(19) United States
(12) Patent Application Publication
(10) Pub. No.: US 2016/0236183 A1
(43) Pub. Date: Aug. 18, 2016

(54) CATALYST FOR THE PRODUCTION OF SYNTHESIS GAS AND PROCESS FOR OBTAINING IT

(71) Applicant: PETRÓLEO BRASILEIRO S.A. - PETROBRAS, Rio de Janeiro - RJ (BR)

(72) Inventors: Antonio Marcos FONSECA BIDART, Rio de Janeiro - RJ (BR); Roberto Carlos PONTES BITTENCOURT, Rio de Janeiro - RJ (BR); Fabio MENEZES PASSARELLI, Rio de Janeiro RJ (BR)

(73) Assignee: PETRÓLEO BRASILEIRO S.A. - PETROBRAS, Rio de Janeiro, RJ (BR)

(21) Appl. No.: 15/029,958

(22) PCT Filed: Oct. 17, 2013
(86) PCT No.: PCT/BR2013/000424

§ 371 Date: Apr. 15, 2016

(51) Int. Cl. B01J 23/89; C01B 3/40; B01J 37/02; B01J 37/08; B01J 23/83; B01J 21/04

(52) U.S. Cl. CPC B01J 23/894; B01J 23/83; B01J 21/04; B01J 37/0213; B01J 37/0236; B01J 37/088; B01J 37/024; C01B 3/40; C01B 2203/0233; C01B 2203/1082; C01B 2203/1058

(57) ABSTRACT

This invention is aimed at making viable a catalyst and the process for obtaining it that besides having a higher resistance to the deposition of coke on the catalyst surface, does not introduce limitations to the process variables, maintains acceptable levels of activity throughout the steam reforming process and has a lower cost of production. The aforementioned objective is achieved by means of a catalyst formed by an inorganic oxide support, a mixture of Nickel, Lanthanum and Cerium and a promoter element.

### INVENTION FIELD

This invention falls into the state-of-the-art of catalysts and processes for the production of catalysts for the production of a mixture of gases rich in hydrogen and carbon monoxide, known in the state-of-the-art as “synthesis gas.” Particularly, the invention relates to a catalyst for the production of “synthesis gas” from a mixture of hydrocarbons and the process for obtaining the aforementioned catalyst.

### BASIS OF THE INVENTION

In general, the gases rich in hydrogen and carbon monoxide, known in the state-of-the-art as “synthesis gas,” are mass-produced for use in petroleum refining, especially in hydrotreating reactions. Moreover, the “synthesis gas” is widely used in the petrochemical industry for the production of synthetic fuels, methanol, ammonia and urea, among others.

With regard to the production of synthetic fuels, “synthesis gas” is produced from a method known in the state-of-the-art as steam reforming of hydrocarbon, being subsequently converted into synthetic fuel through a “Fischer-Tropsch” synthesis.

The production stage of “synthesis gas” is subdivided into two sections: the pre-reforming of the raw material and the recycle stream coming from the “Fischer-Tropsch” synthesis and steam reforming of hydrocarbons. The main reactions occurring in the steam reforming process are the following:

CₙHₘ+nH₂O=nCO+(n+1/2n)H₂

CH₄+H₂O═CO+3H₂

CO+H₂O═CO₂+H₂

The steam reforming process may have different configurations, depending on the type of feedstock and the intended use of the “synthesis gas” to be produced. A particularly advantageous option when the feedstock is naphtha or a mixture of naphtha and natural gas, or when a low steam/carbon ratio is chosen to work with, or when a “synthesis gas” suitable for the production of synthetic fuels is sought, is to include in the process a pre-reforming reactor of the feedstock.

The aforementioned pre-reforming stage is usually carried out in a fixed bed reactor containing a catalyst with a base of nickel at a temperature range comprised between 350° C. and 550° C., steam/carbon ratio comprised in a range of values between 1 and 5 and pressures up to 40 bar. However, it is well known in the state-of-the-art that the nickel-based pre-reforming catalysts are subject to deactivation by coking (Carbon) on the surface. Such phenomenon results in a reduction in the catalyst activity or an increase in the load loss in the reactor or both.

Some factors contribute to accelerate the coking rate on the surface of pre-reforming catalysts, namely: low steam/carbon ratios, low hydrogen/load ratio and the type of feedstock used. It is known that the use of naphtha as a feedstock generates a higher deposition of coke on a pre-reforming catalyst than the use of natural gas, for example. The use of feedstock containing olefins is one of the most important factors in the coking of the aforementioned catalysts.

Thus, the manipulation of the aforesaid operational variables, as well as the appropriate choice of feedstock, so that it is possible to operate outside the thermodynamic range susceptible of coking is a solution, albeit palliative, for the problem.

Various works in patent literature show processes and steam-reformer catalysts of hydrocarbons, which enable the obtaining of a promising solution for the problem of the deposition of coke on the catalyst surface.

U.S. Pat. No. 3,481,722 shows a liquid hydrocarbon steam reforming process which comprises the processing of a hydrocarbon stream, water vapor and hydrogen in a first stage over a catalyst containing a metal of the platinum group at temperatures below 700° C. However, said solution involves high costs, resulting from the substitution of nickel for a noble metal, which limits the use of the catalyst on a large scale.

Document PI 1000656-7 protects a process and a nickel-based steam-reformer catalyst by incorporating alkali metals. If, on the one hand, the addition of alkali metal reduces the deposition of coke on the aforementioned catalyst, on the other hand it is known that nickel-based catalysts for steam reforming the aforementioned alkali metals reduces the activity of the catalyst. To circumvent the problem, a specific method of preparation of the catalyst is shown.

U.S. Pat. No. 7,365,102 describes a pre-reforming process to obtain a hydrocarbon feed stream enriched with methane, which employs an oxidizing gas stream (water) free of molecular oxygen. The mixture is heated to a range of values from 500° C. to 700° C. in the presence of a Ni-based catalyst, by controlling the H₂O/hydrocarbon ratio in the pre-reforming reactor lower than 1, so that the conversion of hydrocarbons with a molecular weight higher than the one of methane does not exceed the 30%-40% range.

U.S. Pat. No. 7,427,388 shows a process for pre-reforming natural gas, that includes putting in contact steam, hydrogen and the aforementioned gas with a nickel-based catalyst and oxygen in an amount lower than the one necessary to partially oxidize the hydrocarbons. The addition of oxygen to the pre-reform process entails additional production costs as a result of the purification of atmospheric air, when used as a source of oxygen. In addition, process limitations resulting from the temperature increase due to the use of oxygen may occur.

Thus, despite the existence of various processes and catalysts to produce “synthesis gas,” alternatives are still being sought that, besides reducing the deposition of coke on the catalyst surface, do not place limitations on the process variables, do not harm the activity of the aforementioned catalyst and that minimize the production costs.

As described below, this invention advantageously has economic gains, because it does not replace nickel with noble metals or alkali metals and does not introduce oxygen into the process, which minimizes the production costs.

### SUMMARY OF THE INVENTION

In a broad way, this invention is aimed at making viable a catalyst for synthesis gas production and the process of obtaining it that besides having a higher resistance to the deposition of coke on the catalyst surface, does not introduce limitations to the process variables, maintains levels of activity throughout the steam reforming process and has a lower cost of production.

The aforementioned objective is achieved through a catalytic process of pre-reforming the hydrocarbons in the presence of water vapor and in the absence of oxygen. The catalyst of the pre-reforming process is formed by an inorganic oxide support, a mixture of Nickel, Lanthanum and Cerium and a promoter element. Thus, this invention advantageously has economic gains, because it does not replace nickel with noble metals or alkali metals and does not introduce oxygen into the process, which minimizes the production costs.

### BRIEF DESCRIPTION OF THE DRAWINGS

The characteristics of this invention will be better understood from the detailed description that will follow, by way of example, associated with the figures referred to below, which are integral parts of this report.

FIG. 1 shows a graph of Temperature (° C.) versus Mass Change (% m/m), which represents the carbon deposition rate of the pre-reforming catalysts known in the state-of-the-art.

FIG. 2 shows a graph of Temperature (° C.) versus Mass Change (% m/m), which compares the carbon deposition rate on various commercial nickel-based pre-reforming catalysts with catalysts prepared in accordance with this invention.

FIG. 3 shows a graph of Temperature (° C.) versus Mass Change (% m/m), which compares the carbon deposition rate on a specific commercial nickel-based pre-reforming catalyst with catalysts obtained in accordance with this invention.

### DETAILED DESCRIPTION OF THE INVENTION

This invention relates to a catalyst for producing a mixture of gases rich in hydrogen and carbon monoxide and the process for obtaining it.

The aforementioned catalyst is intended to be used in a process in which the feedstock is a hydrocarbon stream containing olefins and water vapor and, preferably hydrogen, for example, refinery gas streams or those resulting from the “Fischer-Tropsch” process known in the state-of-the-art as “tail gas”.

The process of the invention occurs at temperatures in a range of values between 250° C. and 600° C., preferably between 350° C. and 500° C. The reagents are injected into a fixed bed reactor which is made up with a catalyst comprising an inorganic oxide support, a mixture of Nickel, Lanthanum and Cerium and a promoter element which can be selected from Boron, Silver, or mixtures of them.

The catalysts thus prepared may be used to produce a gas rich in methane and hydrogen, free of other hydrocarbons, and may contain a variable content of carbon monoxide and carbon dioxide at a pressure in a range between 1 kgf/cm, and 50 kgf/cm and at a temperature in a range of values between 300° C and 650° C.

The gas produced can be used as synthetic natural gas, as a fuel or as fuel cell power supply. Particularly, the gas thus generated may be used in the steam reforming process to produce hydrogen or “synthesis gas.” The steam/carbon ratio in the input of a fixed bed reactor containing the catalyst is comprised in a range of values between 0.1 mol/mol and 5 mol/mol, preferably between 0.5 mol/mol and 2 mol/mol.

The catalyst for the production of a mixture of gases rich in hydrogen and carbon monoxide comprises:
an inorganic oxide support which can be chosen from alumina, calcium aluminate, magnesium aluminate, silica, titania [sic: titanium], and mixtures of those compounds;
a mixture of oxides of Nickel, Lanthanum and Cerium impregnated simultaneously with the aforementioned inorganic oxide support; and
a promoter element, which can be selected from Boron, Silver or mixtures of those compounds.

The mixture of oxides used preferably comprises: NiO, La₂O₃ and Ce₂O₃, wherein the ratio of the mixture of NiO and La₂O₃ is comprised in a range of values between 6:1 (w/w) and 15:1 (w/w) and the ratio of mixture of Ce₂O₃ and La₂O₃ is comprised in a range of values between 2:1 (w/w) and 4:1 (w/w). The total content of NiO present in the catalyst is comprised in a range between 5% (w/w) and 50% (w/w), preferably between 7% (w/w) and 30% (w/w) as the total content of promoter element is comprised in a range of values between 0.3% (w/w) and 2.0% (w/w).

The process for obtaining the catalyst for the production of a mixture of gases rich in hydrogen and carbon monoxide object of this invention comprises the following stages:
1) preparing an aqueous solution of an inorganic Nickel salt, preferably Nickel nitrate, acetate or carbonate, and of Lanthanum and Cerium, preferably in the form of nitrate;
2) impregnating the inorganic oxide support through the wet point technique or through placing said inorganic oxide support in an excess of solution;
3) drying the impregnated material in air, at a temperature in a range of values between 50° C. and 150° C., and for a time interval comprised in a range between 1 and 24 hours;
4) calcining the impregnated material in static air or in an airflow at a temperature in a range of values between 250° C. and 650° C., and for a time interval comprised in a range between 1 and 4 hours;
5) adding to the calcined material a promoter element, which can be selected from Boron, Silver, or mixtures of these compounds, by means of the impregnation technique;
6) drying the impregnated material in air at a temperature comprised in a range of values between 50° C. and 150° C.; and
7) calcining the impregnated material in air at a temperature comprised in a range of values between 250° C. and 650° C.

Alternatively, stages 2, 3 and 4 of the process may be repeated more than once until achieving the desired NiO content on the inorganic oxide support.

Furthermore, the calcining of the stage (7) may be replaced by a direct reduction in flux of a reducing agent, which can be selected from hydrogen, formaldehyde or methanol. The aforementioned direct reduction may occur at a temperature comprised in a range of values between 300° C and 800° C and for a time interval comprised in a range between 1 and 5 hours. Next, the material can be cooled and subjected to an air flow at a temperature comprised in a range of values between 20° C and 60° C, and for a time interval comprised in a range between 1 and 5 hours, to prevent the material having a pyrophoric character when handled.

Additionally, compounds may be included as additives to the solution prepared in stage 1 of the impregnation process to control the pH, increase the solubility, or prevent precipitation in the stages. Non-limiting examples of these compounds are: nitric acid, sulfuric acid, phosphoric acid, ammonium hydroxide, ammonium carbonate, hydrogen peroxide (H₂O₂), sugars or mixtures of these compounds.

Optionally the promoter element or the promoter elements may be impregnated in the inorganic oxide support with Nickel, Lanthanum and Cerium salts.

One way to obtain the impregnation of the inorganic oxide support is to use the wet point technique. In this technique, the aforementioned support is put into contact with a solution, preferably aqueous, of Nickel, Lanthanum and Cerium salts, sufficient to completely fill the pores of the support. The solvent of the impregnation solution can be selected from water, methanol, ethanol or mixtures of these compounds.

Alternatively, the inorganic oxide support may contain a content of alkali metals comprised in a range of values between 0.1% (w/w) and 10% (w/w), preferentially between 1% (w/w) and 5% (w/w). The alkali metal may be introduced beforehand on the support or simultaneously to the impregnation with the Nickel, Lanthanum and Cerium salt solution. The alkali metal used is preferably potassium.

The particles of the inorganic oxide support can be in various forms, such as those customarily suitable for industrial use in a steam reforming process, for example, spheres, cylinders or cylinders with a central hole.

Next, just five series of experiments are presented by way of example which illustrate the invention so that it can be more thoroughly evaluated. In those experiments catalysts are prepared according to the process used in the state-of-the-art and according to the present invention, with the aim of making a comparative analysis of the coke deposition rates and catalytic activity when the catalysts are used in a steam reforming process.

### EXAMPLE 1

This example illustrates the preparation according to the present invention of a catalyst based on Nickel, Lanthanum and Cerium on a support of the alumina kind and promoted by Boron.

One hundred grams of commercial theta-alumina (SP 508F® of Axens, with a pore volume of 0.7 cm³/g and in the shape of spheres 3 mm to 4 mm in diameter) was impregnated with 70 mL of aqueous solution containing 2.95 grams of La(NO₃)₃.6H₂O, 8.82 grams of Ce(NO₃)₃.6H₂0 e 33.03 grams of Ni(NO₃)₂.6H₂0. The material was dried at 60° C. for 2 hours, and then in a first stage, heated in static air at a temperature comprised in a range of values between 60° C. and 120° C. at a rate of 1° C./min. and, in a second stage, up to 250° C. at a 1.4° C./min rate. Then, the catalyst was calcined at 450° C. for 4.5 hours. Thus a Ni—Ce—La/theta-alumina catalyst was obtained containing 7.6% (w/w) of NiO, 1.0 % (w/w) La₂O₃ and 3% (w/w) of Ce₂O₃. Forty grams of this catalyst were, then, impregnated to wet point with 28 mL of aqueous solution containing 2.31 grams of boric acid (H₃BO₄), followed by drying at 95° C. for one night and calcination at 450° C. in static air to obtain a catalyst of the type B—Ni—Ce—La/theta-alumina containing 1% (w/w) Boron and with a specific area of 70.1 m²/g.

### EXAMPLE 2

This example illustrates the preparation of a catalyst according to the present invention based on Nickel, Lanthanum and Cerium on a support of the alumina kind and promoted by Silver.

One hundred grams of commercial theta-alumina (SP 508F® of Axens, with a pore volume of 0.7 cm³/g and in the shape of spheres 3 mm to 4 mm in diameter) was impregnated with 70 mL of aqueous solution containing 2.95 grams of La(NO₃)₃.6H₂O, 8.82 grams of Ce(NO₃)₃.6H₂0 e 33.03 grams of Ni(NO₃)₂.6H₂0. The material was dried at 60° C. for 2 hours, and then in a first stage, heated in static air at a temperature comprised in a range of values between 60° C. and 120° C. at a rate of 1° C./min. and, in a second stage, up to 250° C. at a 1.4° C./min rate. Then, the catalyst was calcined at 450° C. for 4.5 hours. Thus a Ni—Ce—La/theta-alumina catalyst was obtained containing 7.6% (w/w) of NiO, 1.0% (w/w) La₂O₃ and 3% (w/w) of Ce₂O₃. Forty grams of this catalyst were, then, impregnated to wet point with 28 mL of aqueous solution containing 2.31 grams of silver nitrate (AgNO₃), followed by drying at 95° C. for one night and calcination at 450° C. in static air to obtain a catalyst of the type Ag—Ni—Ce—La/theta-alumina containing 0.3% (w/w) silver and with a specific area of 71.8 m²/g.

### EXAMPLE 3

This example illustrates the performance of nickel-based commercial catalyst used for pre-reforming, as to the resistance to the carbon deposition in the pre-reforming conditions of a gas stream containing hydrocarbons, high carbon monoxide content and the absence of olefins, known in the state-of-the-art and identified by the notation C1, C2, C3 and C4.

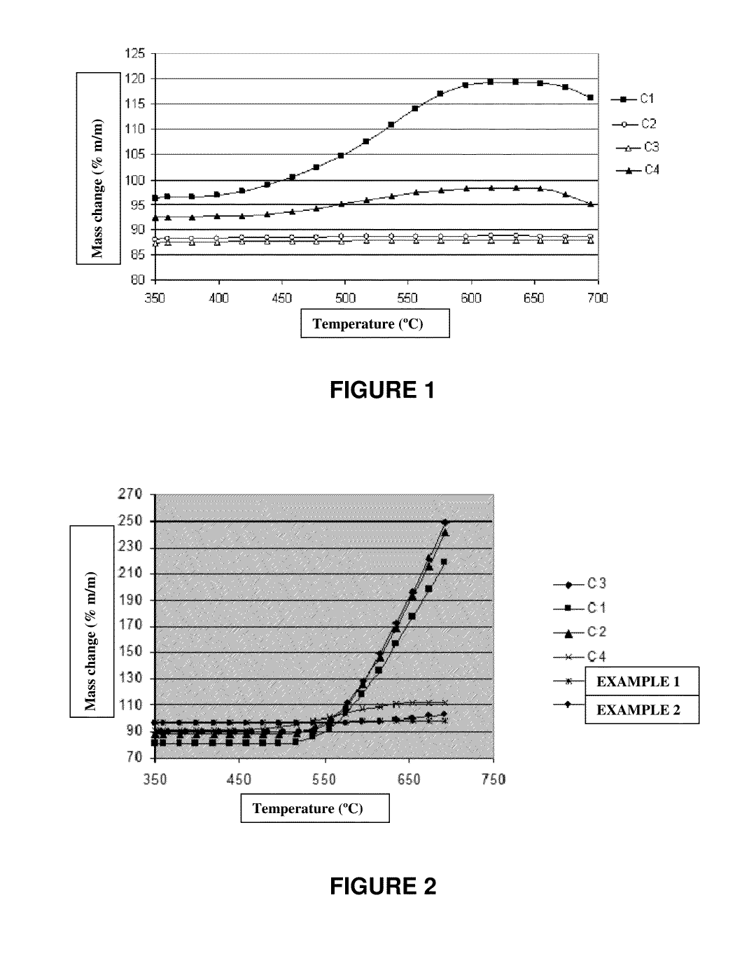

The catalysts were tested in a comparative way in a thermogravimetric analysis equipment (TGA Mettler Toledo TGA/SDTA851E). The tests were conducted using 25 mg of catalyst crushed to obtain particles smaller than 0.088 mm (170 mesh). Initially a stage of pre-treatment was made through the passing of 40 mL/min. of a mixture containing 10% (v/v) of Hydrogen in Argon saturated in water vapor at 15° C. along with 40 mL/min. of Nitrogen (shielding gas). The temperature was programmed within a range of values comprised between 100° C. to 650° C. at a heating rate of 10° C./min., maintained for 1 hour. Then the temperature was reduced to 350° C. and the coking rates were measured through the substitution of the stream H₂/Argon by a synthetic gas stream comprising 21.5% Hydrogen (H₂), 27.3% carbon monoxide (CO), 42.9% carbon dioxide (CO₂) and 8.3% methane (CH₄) saturated with water vapor at 15° C., with programming of the temperature in a range of values comprised between 350° C. and 700° C. at a heating rate of 5° C./min. The carbon deposition results are shown in FIG. 1 in the form of a graph: mass increase (% m/m) versus temperature (° C.).

For a reaction steam/gas ratio of 0.012 mol/mol, the catalysts showed low resistance to carbon deposition, stemming from a significant increase in mass over time (or temperature) of the experiment.

Among the commercial catalysts tested, it can be seen that the material defined with C1 and C4 showed an increase in mass associated with the deposition of carbon, while those materials identified as C2 and C3 did not present, under the same conditions, a significant increase in mass. These results allow us to conclude, from the correct selection of Nickel-based commercial pre-reforming catalysts, that it is possible to obtain a low carbon deposition rate in a steam reforming process of hydrocarbon mixtures with high carbon monoxide content and absence of olefins, even with a low steam/carbon ratio. However, as shown in the next example, such catalysts show a significant increase in carbon deposition rate when the hydrocarbon stream contains olefins.

### EXAMPLE 4

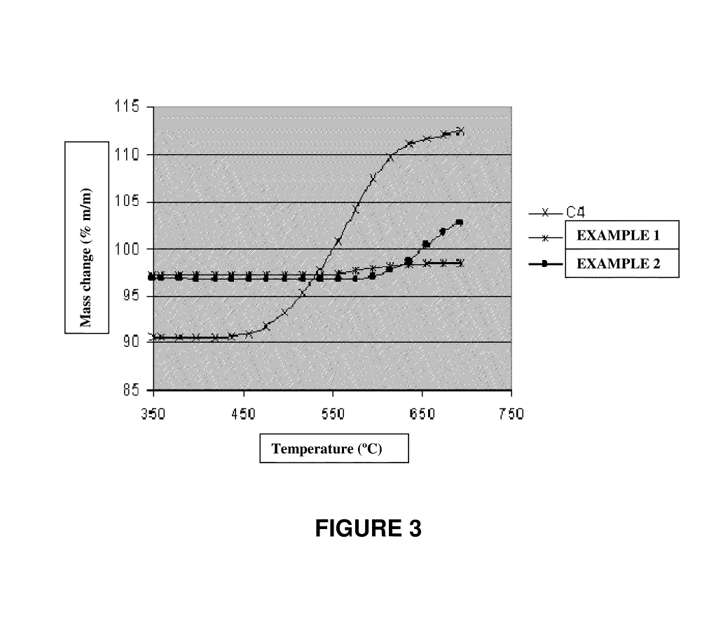

This example illustrates the high resistance to carbon deposition of catalysts prepared according to this invention (Examples 1 and 2) compared to commercial Nickel-based pre-reforming catalysts according to the state-of-the-art (C1, C2, C3 and C4). The experiments were conducted in a manner similar to Example 3, using reaction steam/gas ratios of 0.012 mol/mol and a synthetic stream of the following composition: 21.9% H₂, 13.2% CO 15.9% of CO₂, 43.2% CH₄, 1.77% Nitrogen and 0.20% Ethylene. The carbon deposition results are shown in FIGS. 2 and 3 in the form of graphs: mass increase (% m/m) versus temperature (° C.).

The graphs of FIGS. 2 and 3 show that the catalyst containing Nickel, Cerium, Lanthanum and Boron (Example 1) or Silver (Example 2) with alumina support presents a high resistance to carbon deposition in a steam reforming process of hydrocarbons containing olefins. State-of-the-art commercial catalysts present a high deposition of carbon, which limits their industrial application, given that the high carbon deposition on the catalyst surface can cause a higher loss of mass and increase the deactivation rate.

### EXAMPLE 5

This example illustrates the excellent catalytic activity as well as the resistance to the deposition of carbon of the catalysts in this invention (Example 1 and Example 2) when compared to nickel-based commercial catalysts (C1, C2, C3 and C4) or noble metal (CMN1).

The steam reforming activity was determined in an AutoChem II (Micrometrics) commercial machine. The tests were conducted using 200 mg of catalyst crushed to obtain particles smaller than 0.088 mm (170 mesh). Initially an activation stage was carried out at a temperature of 650° C. through the passing of 40 mL/min. of a mixture containing 10% (v/v) of Hydrogen in Argon saturated in water vapor at 40° C. over the catalyst. The activation had the objective of obtaining an active phase of metallic Nickel. After the activation, the steam reforming reaction was initiated, through the passing of a synthetic stream comprising 21.9% H₂, 13.2% CO, 15.9% CO₂ and 43.62%₄, 1.77% Nitrogen and 0.20% ethanol, saturated with water vapor at 40° C., with a reaction temperature in a range of values comprised between 450° C. and 550° C. The reactor effluent gases were analyzed by mass spectrometry and the catalytic activity measured based on the degree of methane conversion. The results of the analysis are shown in Table 1 below.

TABLE 1

| | Temp. (° C.) | | | |
|---|---|---|---|---|
| | 450 | 450 | 750 | |
| | GHSV (h⁻¹) | | | |
| | 18000 | 6000 | 6000 | Coking Rate |
| | CH₄ | CH₄ | CH₄ | (coke |
| | Conversion | Conversion | Conversion | mg/catalyst |
| Catalyst | (% v/v) | (% v/v) | (% v/v) | mg.min.) |
| C1 | 26.0 | — | — | 5.0 |
| C2 | 21.4 | — | — | 5.6 |
| C3 | 33.3 | — | — | 5.9 |
| C4 | 27.5 | — | — | 0.2 |
| CMN1 | 9.8 | — | — | 0.01 |
| Example 1 | 0 | 14.2 | 21.9 | 0.04 |
| Example 2 | 14.0 | 19.4 | 29.8 | 0.08 |

According to the data presented, obtaining a high catalytic activity in steam reforming processes with the catalysts formulated according to this invention proved to be possible. The result is particularly important if we take into account the low Nickel content used in the “Example 1” and “Example 2” formulations and the absence of noble metals, factors that contribute to minimizing the production costs of the aforementioned catalysts.

With regards to the coking rate, the determination was made in a similar manner to the one described in Example 4. A typical recycle stream of the “Fischer-Tropsch” process was used, with the following composition: 21.9% H₂, 13.2% CO, 15.9% CO₂ and 43.62% CH₄, 1.77% Nitrogen and 0.20% Ethylene. The coking rate, expressed as “coke mg/catalyst mg.min.” was determined from the slope of the graphs of FIGS. 2 and 3.

Table 1 and FIGS. 2 and 3 show that the catalysts formulated according to this invention show a high resistance to carbon deposition (coking), a condition which proves essential to their industrial application. Overall, the catalyst formulated according to this invention show a lower initial steam reforming of hydrocarbon activity, when compared with the commercial pre-reforming catalysts, according to the state-of-the-art (C1, C2, C3 and C4). However, this lower activity proves to be sufficient for a milder industrial use, in which the operating temperature is comprised in a range of values between 450° C. and 550° C., and the space velocities comprised within a range of values between 3,000 h⁻¹ and 6,000 h⁻¹. The conditions of temperature and space velocity mentioned are less severe than the ones used for the comparative evaluation presented in Table 1. Additionally, the activity is still comparable to commercial catalysts based on noble metals, which have the drawback of high cost.

Therefore, the catalyst and the process for obtaining proposed in this invention are a viable alternative for reducing the deposition of coke on the catalyst surface, not introducing limitations to the process variables and not impairing the activity of the aforementioned catalyst and minimizing the production costs.

1. A catalyst for the production of synthesis gas, nickel-based, to be used in a steam reforming process, with greater resistance to the deposition of coke on its surface and catalytic activity, comprising:
an inorganic oxide support;
a mixture of Nickel, Lanthanum and Cerium oxides, in the form of their oxides (NiO, La₂O₃ and Ce₂O₃), which are impregnated simultaneously on the inorganic oxide support; the ratio between the mixture of NiO and La₂O₃ is comprised in a range of values between 6:1 (w/w) and 15:1 (w/w); the ratio of mixture of Ce₂O₃ and La₂O₃ comprised in a range of values between 2:1 (w/w) and 4:1 (w/w) and the total content of NiO in a range comprised between values between 5% (w/w) and 50% (w/w), preferably between 7% (w/w) and 30% (w/w); and
a promoter element comprised in a range of values between 0.3% (w/w) and 2.0% (w/w).

2. The catalyst for the production of synthesis gas according to claim 1, wherein the inorganic oxide of low surface acidity is selected from the group consisting of alumina, calcium aluminate, magnesium aluminate, silica, titanium oxide, and mixtures of these compounds, with a shape selected from spheres, cylinders or cylinders with a central hole.

3. The catalyst for the production of synthesis gas according to claim 1, wherein the promoter element is selected from the group consisting of boron, silver, and mixtures of these compounds.

4. The catalyst for the production of synthesis gas according to claim 1, wherein the inorganic oxide support may contain an alkali metal content comprised in a range of values between 0.1% (w/w) and 10% (w/w), preferentially between 1% (w/w) and 5% (w/w).

5. The catalyst for the production of synthesis gas according to claim 1, wherein the inorganic oxide support contains, alternatively, an alkali metal content comprised in a range of values between 0.1% (w/w) and 10% (w/w).

6. The catalyst for the production of synthesis gas according to claim 1, characterized by the alkali metal content being between 1% (w/w) and 5% (w/w).

7. The catalyst for the production of synthesis gas according to claim 1, wherein the alkali metal is potassium.

8. The catalyst for the production of synthesis gas according to claim 1, characterized by preserving the resistance to coke deposition on its surface and catalytic activity under conditions of temperature and space velocity less severe, within the range of values between 450° C. and 550° C. and 3,000 h⁻¹ and 6,000 h⁻¹, respectively.

9. A process for obtaining a catalyst, as described in claim 1, characterized by the aforementioned method comprising the following stages:
1) preparing an impregnating aqueous solution of an inorganic Nickel salt, preferably Nickel nitrate, acetate or carbonate, and of Lanthanum and Cerium, preferably in the form of nitrate;
2) impregnating the inorganic oxide support through the wet point technique or through placing said inorganic oxide support in an excess of solution;
3) drying the impregnated material in air, at a temperature in a range of values between 50° C. and 150° C., and for a time interval comprised in a range of values between 1 and 24 hours;
4) calcining the impregnated material in static air or in an airflow at a temperature in a range of values between 250° C. and 650° C., and for a time interval comprised in a range between 1 and 4 hours;
5) adding to the calcined material a promoter element, which can be selected from Boron, Silver, or mixtures of these compounds, by means of the impregnation technique;
6) drying the impregnated material in air at a temperature comprised in a range of values between 50° C. and 150° C.; and
7) calcining the impregnated material in air at a temperature comprised in a range of values between 250° C. and 650° C.

10. A process for obtaining a catalyst, according to claim 9, characterized by stages 2, 3 and 4 of the process being repeated more than once.

11. A process for obtaining a catalyst, according to claim 9, characterized by the calcining in stage 7 being alternatively replaced by a direct reduction in flow of a reducing agent.

12. A process for obtaining a catalyst, according to claim 9, wherein the reducing agent is selected from the group consisting of hydrogen, formaldehyde and methanol.

13. A process for obtaining a catalyst, according to claim 9, wherein the direct reduction occurs at a temperature comprised in a range of values between 300° C. and 800° C. and for a time interval comprised in a range between 1 and 5 hours.

14. A process for obtaining a catalyst, according to claim 9, wherein the calcined material is cooled and subjected to an air flow at a temperature comprised in a range of values between 20° C. and 60° C., and for a time interval comprised in a range between 1 and 5 hours.

15. A process for obtaining a catalyst, according to claim 9, wherein the impregnating solution includes one or more control additives, selected from the group consisting of nitric acid, sulfuric acid, phosphoric acid, ammonium hydroxide, ammonium carbonate, hydrogen peroxide (H₂O₂), sugars and mixtures of these compounds.

16. A process for obtaining a catalyst, according to claim 9, characterized by alternatively impregnating the promoter element, the inorganic oxide support along with Nickel, Lanthanum and Cerium salts.

17. A process for obtaining a catalyst, according to claim 9, wherein the solvent of the impregnation solution is water, methanol, ethanol or mixtures of these compounds.
